(19) United States
(12) Patent Application Publication
(10) Pub. No.: US 2026/0264601 A1
(43) Pub. Date: Sep. 10, 2026

(54) VEHICLE CONTROL DEVICE, VEHICLE CONTROL METHOD, AND NON-TRANSITORY STORAGE MEDIUM

(71) Applicant: HONDA MOTOR CO., LTD., Tokyo (JP)

(72) Inventors: Yasuhiro Kurata, Tokyo (JP); Kazuki Odagiri, Tokyo (JP)

(21) Appl. No.: 19/542,940

(22) Filed: Feb. 18, 2026

(30) Foreign Application Priority Data
Mar. 5, 2025 (JP) 2025-034661

(51) Int. Cl. B60Q 1/08; B60Q 1/00; B60Q 1/14; G06V 20/58

(52) U.S. Cl. CPC B60Q 1/085; B60Q 1/0023; B60Q 1/143; G06V 20/58; B60Q 2300/45

(57) ABSTRACT

A vehicle control device including a recognizer that recognizes an object around a vehicle; an operation controller that performs suppression control for suppressing the vehicle approaching the object when the object exists and a degree of approach between the vehicle and the object satisfies a predetermined condition; and a light distribution controller that changes an irradiation range of a headlamp installed in the vehicle from a first range to a second range in which a region above the first range is illuminated, the light distribution controller changing a timing at which the irradiation range in the light distribution control is changed from the first range to the second range in accordance with an operation of the suppression control.

### CROSS-REFERENCE TO RELATED APPLICATION

Priority is claimed on Japanese Patent Application No. 2025-034661, filed Mar. 5, 2025, the content of which is incorporated herein by reference.

### BACKGROUND

### Field of the Invention

The present invention relates to a vehicle control device, a vehicle control method, and a non-transitory storage medium.

### Description of Related Art

In recent years, initiatives to provide access to sustainable transportation systems that also give consideration to people who are in a vulnerable position among traffic participants have been intensifying. To realize this, efforts are being focused on research and development for further improving traffic safety or convenience through the research and development of preventive safety technology such as driving assistance for assisting driver’s driving. For example, a technology for gradually changing an output level of a headlamp in association with an operation of driving assistance of a vehicle is known (see Japanese Unexamined Patent Application, First Publication No. 2022-155830).

### SUMMARY

Meanwhile, in preventive safety technologies of the related art, sufficient consideration has not been given to the control of a headlamp according to a surrounding situation of a vehicle. Specifically, since the recognition of an object and the control of the headlamp have not been sufficiently studied, there have been cases in which the recognition accuracy of the object is decreased due to a lighting state of the headlamp. For example, in a case in which an object exists ahead of the vehicle, the recognition accuracy of the object using a sensor is likely to be decreased depending on a timing at which the headlamp is switched from a low beam to a high beam.

An object of the present application is to provide a vehicle control device, a vehicle control method, and a non-transitory storage medium capable of assisting in the recognition of an object to solve the above problem. More specifically, an object of the present application is to suppress a failure in recognizing an object existing in front of a vehicle due to a timing at which an irradiation range of a headlamp is changed being controlled. Further, another object of the present application is to realize driving assistance using object recognition and contribute to the development of a sustainable transportation system.

The vehicle control device, vehicle control method, and non-transitory storage medium according to the present invention adopt the following configurations.

(1): A vehicle control device according to an aspect of the present invention includes a storage medium configured to store computer-readable instructions; and one or more processors connected to the storage medium, wherein the one or more processors execute the computer-readable instructions to: recognize an object around a vehicle; perform suppression control for suppressing the approach of the vehicle to the object when the object exists and a degree of approach between the vehicle and the object satisfies a predetermined condition; and change a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range..

(2): In the aspect (1), the one or more processors execute the computer-readable instructions to set a waiting time when changing from the first range to the second range in the light distribution control in accordance with the operation of the suppression control.

(3): In the aspect (1), the one or more processors execute the computer-readable instructions to: set the waiting time to a first waiting time when the suppression control is not operating during the waiting time; and set the waiting time to a second waiting time, the second waiting time being a time longer than the first waiting time when the suppression control is operating at the time of start of time measurement of the waiting time.

(4): In the aspect (1), the one or more processors execute the computer-readable instructions to change the waiting time from the first waiting time to the second waiting time when the suppression control operates during time measurement of the first waiting time.

(5): In the aspect (1), the one or more processors execute the computer-readable instructions to: when the waiting time is set to the first waiting time, time measurement of the first waiting time is started from a first point in time, and the suppression control operates after the time measurement is started, change the waiting time from the first waiting time to the second waiting time; and start time measurement of the second waiting time from the first point.

(6): In the aspect (1), the one or more processors execute the computer-readable instructions to when the waiting time is set to the second waiting time according to the suppression control, and a different suppression control operates during time measurement of the second waiting time, prevent changing the waiting time from the second waiting time.

(7): In the aspect (1), the one or more processors execute the computer-readable instructions to: perform control for gradually changing the irradiation range from the first range to the second range in the light distribution control; and continue the gradually changing control when the suppression control operates during the gradually changing control after the waiting time has elapsed.

(8): A vehicle control method according to an aspect of the present invention includes recognizing, by a computer, an object around a vehicle; performing, by the computer, suppression control for suppressing the approach of the vehicle to the object when the object exists and a degree of approach between the vehicle and the object satisfies a predetermined condition; and changing a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range.

(9): A non-transitory storage medium storing a program according to an aspect of the present invention causes a computer to recognize an object around a vehicle; perform suppression control for suppressing the approach of the vehicle to the object when the object exists and a degree of approach between the vehicle and the object satisfies a predetermined condition; and change a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range.

According to the above aspects (1) to (9), with the vehicle control device, vehicle control method, and non-transitory storage medium, it is possible to assist in the recognition of an object by changing a timing at which the irradiation range is changed in accordance with an operation state of the suppression control.

According to the above aspects (2) to (3), when the suppression control is operating or has operated at the time of the start of the time measurement of the waiting time or during the time measurement, it is possible to suppress a decrease in the recognition accuracy of an object in consideration of an operation timing of the suppression control by setting a longer waiting time than when the suppression control is not operating.

According to the above aspects (4) to (5), when the suppression control operates during the time measurement of the first waiting time, it is possible to appropriately set and measure the second waiting time to suppress a decrease in the recognition accuracy of an object by setting the second waiting time based on a point in time at which the time measurement of the first waiting time starts.

According to the above aspect (6), when the suppression control operates during the time measurement of the second waiting time, it is possible to perform light distribution control at an appropriate timing without making the second waiting time excessively long by not changing the second waiting time.

According to the above aspect (7), when the suppression control operates during the control in which the irradiation range is gradually changed, it is possible to make it easier for the driver to recognize a surrounding situation by continuing the control in which the irradiation range is gradually changed.

### BRIEF DESCRIPTION OF THE DRAWINGS

FIG. 1 is a configuration diagram of a vehicle system using a vehicle control system according to an embodiment.

FIG. 2 is a diagram showing an example of a scene to which processing that does not delay a timing at which an irradiation range is changed is applied.

FIG. 3 is a diagram showing an example of a time chart in the scene to which processing that does not delay a timing at which an irradiation range is changed is applied.

FIG. 4 is a diagram showing an irradiation range of a headlamp.

FIG. 5 is a diagram showing an example of a scene to which processing of the present embodiment is applied.

FIG. 6 is a diagram showing an example of a time chart in a scene to which the processing of the present embodiment is applied.

FIG. 7 is a diagram showing another example of a time chart in a scene to which the processing of the present embodiment is applied.

FIG. 8 is a flowchart showing an example of a flow of processing executed by the driving assistance device.

### DETAILED DESCRIPTION OF THE EMBODIMENTS

### Overall Configuration

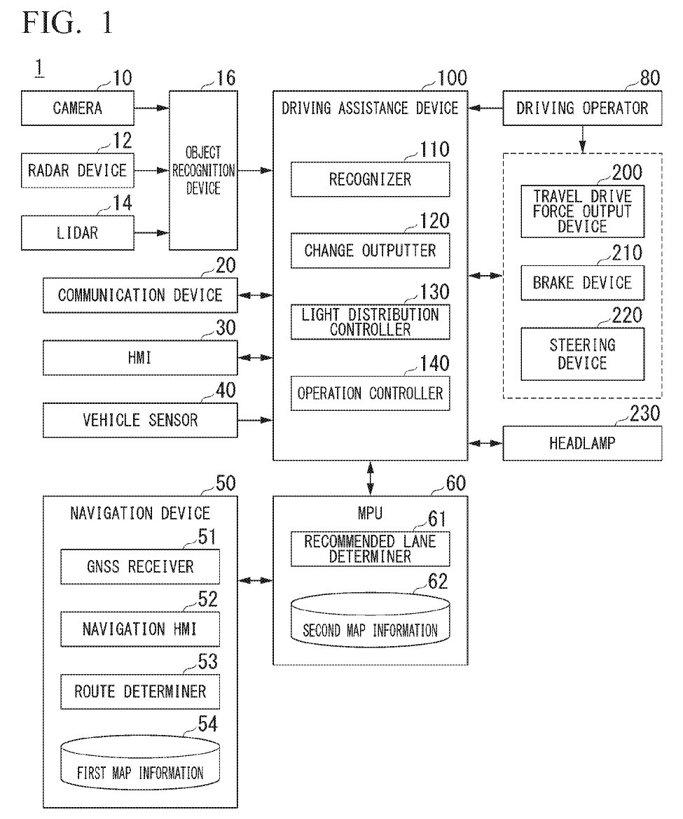

FIG. 1 is a configuration diagram of a vehicle system 1 using a vehicle control system according to an embodiment. A vehicle on which the vehicle system 1 is mounted is, for example, a two-wheeled, three-wheeled, or four-wheeled vehicle, and a driving source thereof is an internal combustion engine such as a diesel engine or a gasoline engine, an electric motor, or a combination thereof. The electric motor operates using electric power generated by a generator connected to the internal combustion engine or electric power discharged from a secondary battery or a fuel cell. The present embodiment will be described as being applied to a vehicle, but present embodiment may also be applied to other vehicles instead of a vehicle.

The vehicle system 1 includes, for example, a camera 10, a radar device 12, a light detection and ranging (LIDAR) 14, an object recognition device 16, a communication device 20, a human machine interface (HMI) 30, vehicle sensors 40, a navigation device 50, a map positioning unit (MPU) 60, an operator 80, a driving assistance device 100, a travel drive force output device 200, a brake device 210, a steering device 220, and a headlamp 230. These devices or units are interconnected by a multiplex communication line such as a controller area network (CAN) communication line, a serial communication line, or a wireless communication network, or the like. The configuration shown in FIG. 1 is merely an example, part of the configuration may be omitted, or additional configurations may be added. The driving assistance device 100 is an example of the “vehicle control device.”

The camera 10 is, for example, a digital camera that uses a solid-state imaging element such as a charge coupled device (CCD) or a complementary metal oxide semiconductor (CMOS). The camera 10 is attached to any location of a vehicle (hereinafter referred to as the vehicle M) on which the vehicle system 1 is mounted. When imaging the front, the camera 10 is attached to, for example, an upper portion of a front windshield or a rear surface of a room mirror. The camera 10 periodically and repeatedly images surroundings of the vehicle M. The camera 10 may be a stereo camera.

The radar device 12 radiates radio waves such as millimeter waves to the surroundings of the vehicle M and detects radio waves (reflected waves) reflected by an object, thereby detecting at least a position (distance and direction) of the object. The radar device 12 may be attached at any location on the vehicle M. The radar device 12 may detect the position and speed of the object using a frequency modulated continuous wave (FM-CW) scheme. The radar device 12 is also attached to, for example, front corners (left and right) of the vehicle M. This allows the radar device 12 to detect an object that is about to cross in front of the vehicle M.

The LiDAR 14 irradiates the surroundings of the vehicle M with light (or electromagnetic waves with a wavelength close to that of light) and measures scattered light. The LiDAR 14 detects a distance to a target based on time from light emission to light reception. The radiated light is, for example, pulsed laser light. The LiDAR 14 is attached at any position on the vehicle M.

The object recognition device 16 performs sensor fusion processing on detection results from some or all of the camera 10, the radar device 12, and the LiDAR 14 to recognize a position, type, speed, and the like of an object. The object recognition device 16 outputs a recognition result to the driving assistance device 100. The object recognition device 16 may output the detection results of the camera 10, the radar device 12, and the LiDAR 14 directly to the driving assistance device 100. The object recognition device 16 may be omitted from the vehicle system 1.

The communication device 20 uses, for example, a cellular network, a Wi-Fi network, Bluetooth (registered trademark), dedicated short range communication (DSRC), or the like to communicate with other vehicles present around the vehicle M or communicate with various server devices via a wireless base station.

The HMI 30 presents various types of information to the occupants of the vehicle M and receives input operations from the occupants. The HMI 30 includes various display devices, speakers, buzzers, touch panels, switches, keys, and the like. The HMI 30 includes a display device. The display device is, for example, a display device that is provided in a central portion of an instrument panel of the vehicle M to display various kinds of information in the vehicle M, such as a speedometer that represents a traveling speed of the vehicle M or a tachometer that represents a rotation speed (rotational speed) of an internal combustion engine included in the vehicle M, that is, a so-called multi-information display.

The vehicle sensor 40 includes a vehicle speed sensor that detects the speed of the vehicle M, an acceleration sensor that detects acceleration, a yaw rate sensor that detects angular velocity around a vertical axis, a direction sensor that detects the orientation of the vehicle M, a sensor that detects a steering rotation angle, and the like.

The navigation device 50 includes, for example, a global navigation satellite system (GNSS) receiver 51, a navigation human machine interface (HMI) 52, and a route determiner 53. The navigation device 50 stores first map information 54 in a storage device such as a hard disk drive (HDD) or a flash memory. The GNSS receiver 51 determines the position of the vehicle M based on signals received from GNSS satellites. The position of the vehicle M may also be determined or supplemented by an inertial navigation system (INS) using an output of the vehicle sensor 40. The navigation HMI 52 includes a display device, a speaker, a touch panel, keys, and the like. Part or all of the navigation HMI 52 may be shared with the HMI 30 described above. The route determiner 53 determines a route (hereinafter referred to as a “map route”) from a position of the vehicle M identified by the GNSS receiver 51 (or any input position) to the destination entered by the occupant using the navigation HMI 52, with reference to the first map information 54. The first map information 54 is information in which a road geometry is represented by links indicating roads and nodes connected by the links. The first map information 54 may include, for example, road curvature or point of interest (POI) information. The map route is output to the MPU 60. The navigation device 50 may provide route guidance using the navigation HMI 52 based on the map route. The navigation device 50, for example, may also be realized using functions of a terminal device such as a smartphone or tablet owned by the occupant. The navigation device 50 may transmit a current location and destination to a navigation server via the communication device 20 and acquire a route equivalent to the map route from the navigation server.

The MPU 60 includes, for example, a recommended lane determiner 61 and stores second map information 62 in a storage device such as an HDD or flash memory. The recommended lane determiner 61 divides the map route provided by the navigation device 50 into a plurality of blocks (for example, every 100 meters in a direction in which the vehicle travels) and determines a recommended lane for each block by referring to the second map information 62. The recommended lane determiner 61 determines, for example, which lane number from the left the vehicle travels in. When there is a branch location on the map route, the recommended lane determiner 61 determines a recommended lane that allows the vehicle M to travel on a reasonable path toward a branch destination. For example, when the vehicle M reaches a position a predetermined distance before the branch road on which the vehicle M is to travel, the recommended lane determiner 61 determines a lane connected to the branch road to be the recommended lane. The recommended lane determiner 61 and the second map information 62 may be a functional unit or information included in other devices such as the driving assistance device 100. Information on the recommended lane is provided to the driver via the HMI, for example.

The second map information 62 is map information having higher accuracy than the first map information 54. The second map information 62 includes, for example, information on a center of a lane or information on boundaries of the lane. The second map information 62 may include road information, traffic regulation information, address information (address and postal code), facility information, telephone number information, and the like. The second map information 62 may be updated at any time by the communication device 20 communicating with another device.

The operator 80 includes, for example, a steering wheel, an accelerator pedal, a brake pedal, a shift lever, and other operators. A sensor that detects an operation amount or the presence or absence of an operation is attached to the operator 80, and a result of the detection is output to some or all of the driving assistance device 100, the travel drive force output device 200, the brake device 210, and the steering device 220. The steering wheel does not necessarily need to be annular and may be in the form of an irregularly shaped steering wheel, a joystick, buttons, or the like.

The driving assistance device 100 includes, for example, a recognizer 110, a change outputter 120, a light distribution controller 130, and an operation controller 140. The recognizer 110, the change outputter 120, the light distribution controller 130, and the operation controller 140 are realized, for example, by a hardware processor such as a central processing unit (CPU) executing a program (software). Some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by cooperation between software and hardware. The program may be stored in a storage of the driving assistance device 100 such as an HDD or flash memory (a storage device including a non-transitory storage medium) in advance, or may be stored in a removable storage medium such as a DVD or CD-ROM and installed in the HDD or flash memory of the driving assistance device 100 by the storage medium (a non-transitory storage medium) being mounted in a drive device.

The recognizer 110 recognizes states such as a position and speed or acceleration of the object around the vehicle M based on surrounding information input via the object recognition device 16 from the camera 10, the radar device 12, and the LiDAR 14. The position of the object is recognized, for example, as a position on an absolute coordinate system with a representative point (such as a center of gravity or drive axle center) of the vehicle M as an origin, and is used for control. The position of the object may be represented by a representative point such as a center of gravity or a corner of the object, or may be represented by a region. The “state” of the object may include acceleration or jerk of the object, or a “behavior state” (for example, whether or not the object is changing lanes or is about to change lanes).

The recognizer 110 recognizes, for example, a travel path of the vehicle M and other travel paths existing in the surroundings. The travel path is a path on a road including, for example, a lane (travel lane) on which the vehicle M travels or an oncoming lane thereof, and the like. For example, the recognizer 110 recognizes the travel paths by comparing a pattern of road markings (for example, an arrangement of solid lines and broken lines) obtained from the second map information 62 with a pattern of road markings around the vehicle M recognized from an image captured by the camera 10. The recognizer 110 may recognize the travel paths by recognizing not only road markings but also a travel path boundary (road boundary) including road markings, shoulders, curbstones, median strips, guardrails, and the like. In this recognition, the position of the vehicle M acquired from the navigation device 50 or a processing result using an INS may be taken into consideration. The recognizer 110 recognizes a stop line, an obstacle, a red signal, a tollgate, and other road events existing around the vehicle M.

The recognizer 110 recognizes a behavior of the vehicle M based on a detection result of the vehicle sensor 40. For example, when the recognizer 110 recognizes the travel path, the recognizer 110 recognizes a position or posture of the vehicle M with respect to the travel path. The recognizer 110 may recognize, for example, a deviation of a reference point of the vehicle M from the lane center and an angle formed with respect to a line connecting lane centers in the traveling direction of the vehicle M, as a relative position and posture of the vehicle M with respect to the travel path. Alternatively, the recognizer 110 may recognize, for example, a position of the reference point of the vehicle M relative to either side edge (road marking or road boundary) of the travel path, as the relative position of the vehicle M with respect to the travel path.

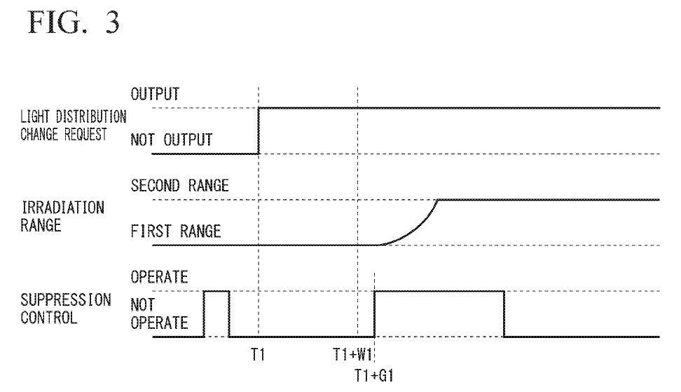

The change outputter 120 outputs to the light distribution controller 130 a light distribution change request, which is a request to start light distribution control to be described later. The light distribution change request is output based on a recognition result from the recognizer 110. For example, the change outputter 120 outputs the light distribution change request depending on whether or not a vehicle traveling on an oncoming lane is recognized (for details, see FIGS. 3, 6, and 7). The change outputter 120 cooperates with the light distribution controller 130 to control the headlamp 230, for example, so that a first range (for example, an irradiation range of a low beam) to be described later is irradiated with the headlamp 230 when there is no oncoming vehicle or preceding vehicle ahead of the vehicle M, and a second range (for example, an irradiation range of a high beam) to be described later is irradiated with the headlamp 230 when there is an oncoming vehicle or preceding vehicle ahead of the vehicle M. The change outputter 120 and the light distribution controller 130 realize an auto high beam function. In the present embodiment, an example in which the auto high beam function is executed in the case of an on state will be described, but alternatively (or additionally), processing may be executed when the auto high beam function is off and switching from a low beam to a high beam is performed according to a driver’s operation.

The light distribution controller 130 controls an irradiation range of the headlamp 230. The light distribution controller 130 executes, for example, light distribution control which is control for changing the irradiation range of the headlamp 230 from the first range to the second range that is a range above the first range. When the surroundings of the vehicle M are dark, the second range may be a range in which visibility becomes better as compared with the first range. For example, the first range may be an irradiation range of a so-called low beam, and the second range may be an irradiation range of a so-called high beam. The second range may be a wider range in an upward direction than the first range. The light distribution control may be control for gradually changing the irradiation range of the headlamp 230 from the first range to the second range. Details of processing of the light distribution controller 130 will be described later.

The operation controller 140 controls all of respective components included in the driving assistance device 100 and the vehicle system 1. The operation controller 140 controls, for example, steering of the vehicle M, controls the speed of the vehicle M, and controls the HMI 30 to provide information to the driver.

The operation controller 140 controls the vehicle M in accordance with a determination result based on the surrounding information detected by the object recognition device 16. Specifically, when it is determined that a degree of approach between an object recognized as existing around the vehicle M based on the surrounding information and the vehicle M satisfies a predetermined condition, the operation controller 140 performs suppression control, which is control based on the degree of approach between the vehicle M and the object. The degree of approach may be calculated, for example, based on a distance between the vehicle M and the object, or may be calculated based on a margin time until the vehicle M and the object come into contact with each other. The predetermined condition may be, for example, “the distance between the vehicle M and the object is less than a predetermined value” or “a margin time between the vehicle M and the object is less than a predetermined time.” The predetermined condition may be a condition using the degree of approach between the vehicle M and the object. The suppression control is, for example, control for suppressing the degree of approach between the vehicle M and the object. The control for suppressing the degree of approach includes, for example, speed adjustment assistance and an alarm. The speed adjustment assistance is control for adjusting the speed of the vehicle M. The speed adjustment assistance may be deceleration control that is control for lowering the traveling speed of the vehicle M or control for decelerating or stopping the vehicle M. The alarm prompts a driver to pay attention to the fact that the degree of approach between the vehicle M and the object satisfies a predetermined condition. The alarm may be executed, for example, by displaying a warning image, may be executed by outputting a voice, or may be executed by vibrating the steering wheel. For example, the degree of the alarm may become stronger as the likelihood of approach increases. For example, when the degree of approach is not suppressed after a warning is displayed, an alarm by sound may be performed in addition to the display. The operation controller 140 executes so-called collision mitigation brake system (CMBS) control.

The travel drive force output device 200 outputs travel drive force (torque) for travel of the vehicle M to drive wheels. The travel drive force output device 200 includes, for example, a combination of an internal combustion engine, an electric motor, a transmission, and the like, and an ECU that controls these. The ECU controls the above configuration in accordance with information input from the driving assistance device 100 or information input from the operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor in accordance with information input from the driving assistance device 100 or the information input from the operator 80 so that brake torque according to a braking operation is output to each wheel.

The steering device 220 includes, for example, a steering ECU and an electric motor. The electric motor, for example, applies force to a rack-and-pinion mechanism to change a direction of steered wheels. The steering ECU drives the electric motor in accordance with the information input from the driving assistance device 100 or the information input from the operator 80 to change the direction of the steered wheels.

The headlamp 230 is, for example, a headlamp that irradiates the front of the vehicle M. The headlamp 230 may be a variable light distribution type of headlamp (ADB: Adaptive Driving Beam) that is capable of changing light distribution of light that is output. The light distribution of light indicates an output direction of light and an output level of light. The headlamp 230 is configured to radiate light in the traveling direction of the vehicle M.

### Details of Processing

In the present embodiment, when the light distribution controller 130 changes the irradiation range of the headlamp 230 from the first range to the second range, the light distribution controller 130 changes a timing at which the irradiation range is changed in accordance with (based on) the operation of the suppression control. For example, when the suppression control is operating and when the irradiation range is changed from the first range to the second range, the light distribution controller 130 delays the timing at which the irradiation range is changed to assist in the recognition of an object. Processing that does not delay the timing at which the irradiation range is changed in scene 1 will be described, and processing that delays the timing at which the irradiation range is changed in scene 2 will be described.

### Scene 1

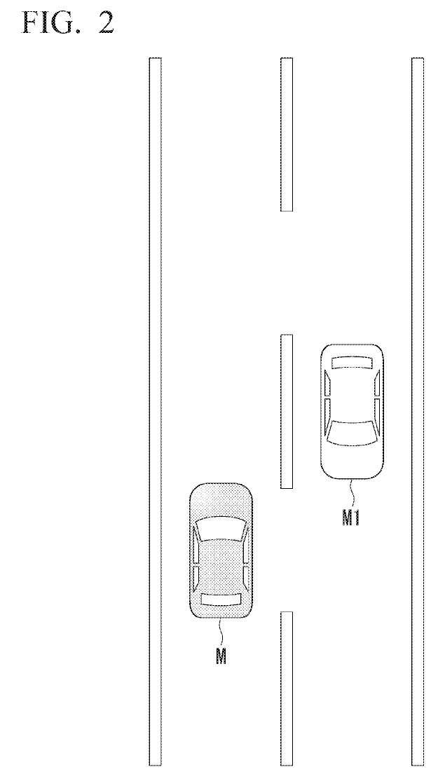

FIG. 2 is a diagram showing an example of a scene to which processing that does not delay a timing at which the irradiation range is changed is applied. In FIG. 2, an oncoming vehicle M1 is traveling on an oncoming lane of a lane on which the vehicle M is traveling. In this scene, it is immediately before the vehicle M and the oncoming vehicle M1 pass each other. In this case, the change outputter 120 outputs the light distribution change request to start the light distribution control for changing the irradiation range of the headlamp 230 from the first range (low beam) to the second range (high beam). When the light distribution change request is output, the light distribution controller 130 sets a waiting time and executes the light distribution control after the waiting time has elapsed.

In the scene of FIG. 2, since no object interfering with the vehicle M is present ahead of the vehicle M and the suppression control is not operating, the waiting time is set to a first waiting time. The first waiting time is a waiting time for light distribution control in a case in which the suppression control is not operating. The first waiting time is a preset time, the first waiting time may be set, for example, according to the type of the vehicle M, or may be set according to an installation position of the headlamp 230. That is, in the scene of FIG. 2, when the light distribution change request is output, the light distribution controller 130 starts the time measurement of the first waiting time and executes the light distribution control after the first waiting time has elapsed. Accordingly, when the vehicle M and the oncoming vehicle M1 pass each other, the vehicle M irradiates the front with a low beam to suppress a driver of the oncoming vehicle M1 feeling dazzled, and the vehicle M irradiates the front with a high beam immediately after the vehicle M and the oncoming vehicle M1 have passed each other, to secure a field of view of the driver of the vehicle M.

FIG. 3 is a diagram showing an example of a time chart in a scene to which the processing that does not delay the timing at which the irradiation range is changed is applied. The time chart in FIG. 3 is a time chart in a time series including before and after the scene shown in FIG. 2. The time chart in FIG. 3 shows the presence or absence of output of the light distribution change request from the change outputter 120, the irradiation range of the headlamp controlled by the light distribution controller 130, and the presence or absence of the operation of the suppression control in the operation controller 140. At time T1, the change outputter 120 outputs the light distribution change request. In this case, since the suppression control is not operating, the light distribution controller 130 sets the waiting time to the first waiting time and starts time measurement. At time T1, the irradiation range of the headlamp 230 is the first range. At time T1 (a starting point of the first waiting time) to time T1 + W1 (an ending point of the first waiting time) after the first waiting time has elapsed, the light distribution controller 130 starts the light distribution control, and the irradiation range of the headlamp 230 is gradually changed from the first range to the second range.

Even when the suppression control has operated before the time measurement of the first waiting time (before time T1), the light distribution controller 130 sets the first waiting time without taking the suppression control into consideration. When the light distribution control has started and the suppression control operates during control of gradual change control that is control for gradually changing the irradiation range from the first range to the second range, the light distribution controller 130 may continue the gradual change control. At time T1 + W1, the light distribution control starts, and the irradiation range is gradually changed from the first range to the second range. Even when the suppression control operates at time T1 + G1, the light distribution controller 130 continues the gradual change control as is. Even when the suppression control operates during the gradual change control, the gradual change control is not affected.

Thus, when the suppression control operates during the gradual change control, the gradual change control continues, making it possible to appropriately assist a driver in recognizing a surrounding situation. For example, when the vehicle M and the oncoming vehicle M1 pass each other and the irradiation range is being changed from the first range to the second range after a first time has elapsed, it is estimated that the oncoming vehicle M1 is already located behind the vehicle M and that the visibility is good. In this situation, when the pedestrian P exists and the suppression control is operated, the gradual change control continues to make it easy for the driver to recognize the surrounding situation, thereby the driver executing control for decelerating the vehicle M with respect to the pedestrian P. That is, it is possible to support traffic safety by appropriately assisting the driver in recognizing the surrounding situation.

### Scene 2

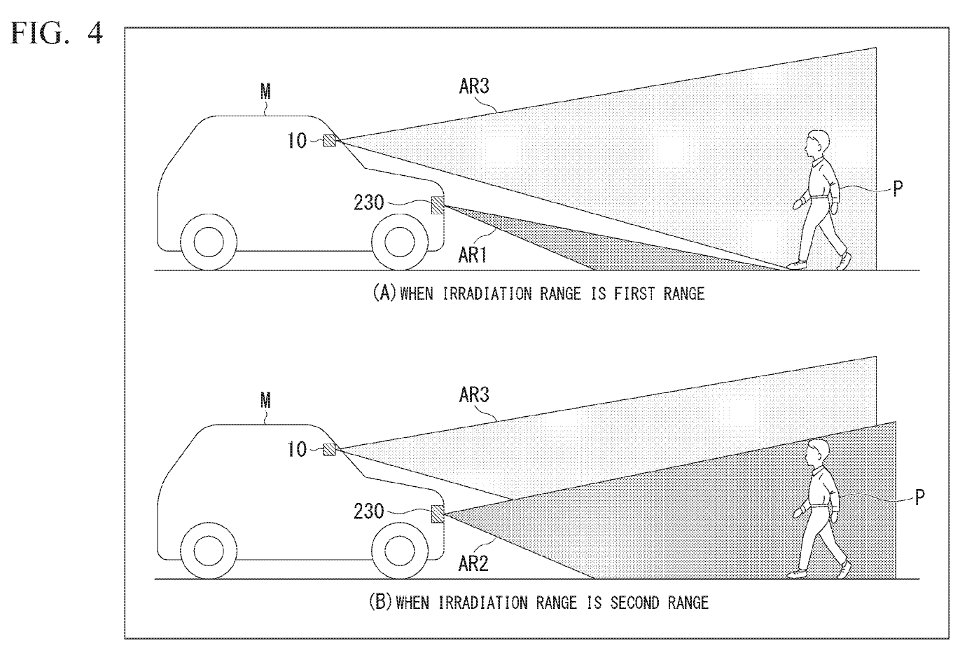

FIG. 4 is a diagram showing the irradiation range of the headlamp 230. FIG. 4 shows a case (A) where the irradiation range is a first range AR1 and a case (B) where the irradiation range is a second range AR2 in a scene in which the pedestrian P exists in the traveling direction of the vehicle M. (A) and (B) show a relationship among the irradiation range (the first range AR1 or the second range AR2) of the headlamp 230, an imaging range AR3 of the camera 10, and the pedestrian P.

In (A) and (B), a degree of approach between the pedestrian P and the vehicle M satisfies a predetermined condition, and the suppression control is executed by the operation controller 140. When the irradiation range is the first range AR1, the pedestrian P does not exist in the first range AR1. When the irradiation range is the second range AR2, the pedestrian P exists in the second range AR2.

The pedestrian P is detected, for example, by the camera 10. In (A) and (B), the pedestrian P is included in the imaging range AR3 of the camera 10. When the pedestrian P is included in the imaging range AR3, the recognizer 110 recognizes the pedestrian P; therefore, in (A) and (B), the recognizer 110 recognizes the pedestrian P. When the irradiation range is the first range AR1, the imaging range AR3 and the first range AR1 do not overlap. When the irradiation range is the second range AR2, the imaging range AR3 and the second range AR2 overlap. That is, in (A) and (B), brightness of the imaging range AR3 differs.

When the irradiation range is changed from the first range AR1 to the second range AR2, the recognizer 110 may fail to recognize the pedestrian P due to a change in brightness in the imaging range AR3. Specifically, when the brightness in the imaging range AR3 changes greatly, a part of a captured image captured by the camera 10 becomes excessively bright, and part or all of information included in the captured image is likely to be lost. When information on the pedestrian P included in the captured image is lost, the camera 10 does not detect the pedestrian P, and the recognizer 110 does not recognize the pedestrian P.

The suppression control with respect to the pedestrian P is executed when the pedestrian P is recognized by the recognizer 110 and the degree of approach between the pedestrian P and the vehicle M satisfies the predetermined condition. That is, when the pedestrian P is not recognized by the recognizer 110, the suppression control with respect to the pedestrian P is not executed.

As described above, even when the pedestrian P actually exists and the degree of approach between the pedestrian P and the vehicle M satisfies the predetermined condition, the recognizer 110 may fail to recognize the pedestrian P due to the irradiation range being changed from the first range to the second range, and the suppression control may not operate or the suppression control that had been operating may end. Therefore, in the processing of the present embodiment, a waiting time for the irradiation range to be changed from the first range to the second range is changed in accordance with the operation of the suppression control to suppress the recognizer 110 becoming less able to recognize the pedestrian P due to the change in the irradiation range, as will be described below.

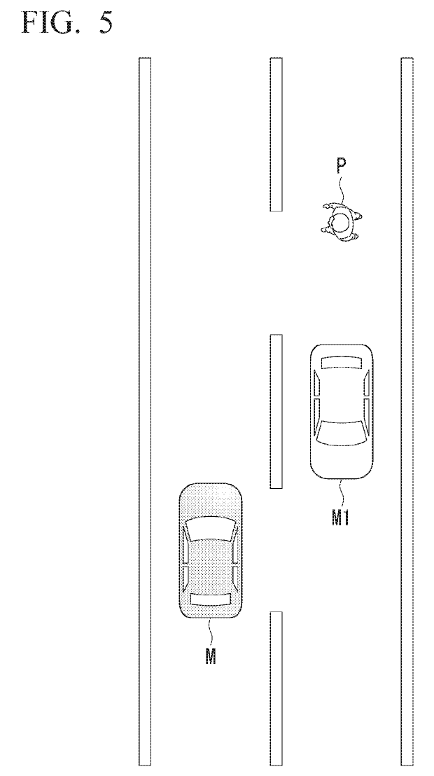

FIG. 5 is a diagram showing an example of a scene to which the processing of the present embodiment is applied. In FIG. 5, there are the oncoming vehicle M1 traveling on an oncoming lane of the lane on which the vehicle M is traveling, and the pedestrian P crossing a road behind the oncoming vehicle M1. In this scene, the vehicle M and the oncoming vehicle M1 are just before passing each other. In this case, the change outputter 120 outputs the light distribution change request to start the light distribution control for changing the irradiation range of the headlamp 230 from the first range (low beam) to the second range (high beam). When the light distribution change request is output, the light distribution controller 130 sets a waiting time and executes the light distribution control after the waiting time has elapsed.

In the scene of FIG. 5, the recognizer 110 recognizes that the pedestrian P exists. Since the pedestrian P is recognized, the operation controller 140 derives the degree of approach between the pedestrian P and the vehicle M. In this case, since the degree of approach between the pedestrian P and the vehicle M satisfies the predetermined condition, the operation controller 140 executes the suppression control with respect to the pedestrian P.

When the waiting time is set to the first waiting time, the suppression control is executed after waiting for the first time, and in this case, the light distribution control for changing the irradiation range from the first range to the second range is executed. When the light distribution control is performed, there is a possibility that a change in luminance of the pedestrian P becomes large, making the recognition of the pedestrian P in the recognizer 110 difficult and causing the operation of the suppression control to stop, as described with reference to FIG. 4. Therefore, when the suppression control has operated (in the scene of FIG. 5), the waiting time is set to a second waiting time that is a time longer than the first waiting time. Accordingly, a timing at which the light distribution control for changing the irradiation range from the first range to the second range is executed is delayed, and the second waiting time at which the light distribution control is executed after the suppression control has ended or after the driver has recognized a target of the suppression control may be set, for example, in accordance with the intensity of the suppression control. The second waiting time may be, for example, a time obtained by adding a margin time to the first waiting time. That is, in the scene of FIG. 5, when the light distribution change request is output, the light distribution controller 130 starts time measurement of the second waiting time and executes the light distribution control after the second waiting time has elapsed.

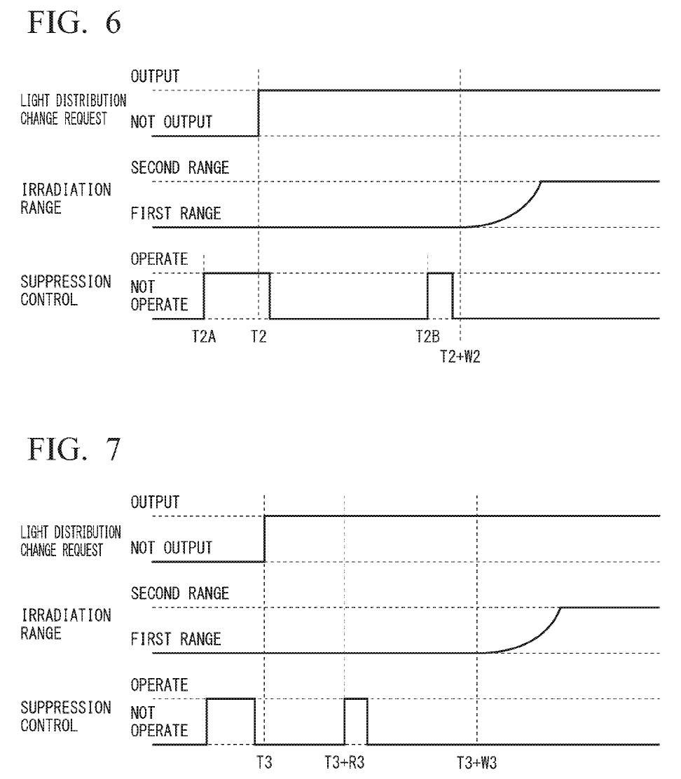

FIG. 6 is a diagram showing an example of a time chart in a scene to which the processing of the present embodiment is applied. The time chart in FIG. 6 is a time chart in a time series including before and after the scene shown in FIG. 5. The time chart in FIG. 6 shows the presence or absence of output of the light distribution change request from the change outputter 120, the irradiation range of the headlamp controlled by the light distribution controller 130, and the presence or absence of the operation of the suppression control in the operation controller 140, similar to the time chart in FIG. 3. At time T2, the change outputter 120 outputs the light distribution change request. In this case, since the suppression control is operating, the light distribution controller 130 sets the waiting time to the second waiting time and starts time measurement. At time T2, the irradiation range of the headlamp 230 is the first range. At time T2 (a starting point of the second waiting time) to time T2 + W2 (an end point of the second waiting time) after the second waiting time has elapsed, the light distribution controller 130 starts the light distribution control, and the irradiation range of the headlamp 230 is gradually changed from the first range to the second range.

Thus, when the suppression control is operating at the time of output of the light distribution change request (at the start of the time measurement of the waiting time), the waiting time for the light distribution control is set to the second waiting time, making it possible to assist in the recognition of an object. For example, in a case in which the suppression control with respect to the pedestrian P is operating when the vehicle M and the oncoming vehicle M1 pass each other and the light distribution change request is output, the light distribution controller 130 sets the waiting time to the second waiting time and executes the light distribution control after the second waiting time has elapsed. By setting the waiting time to a time longer than the first waiting time, it is possible to delay a timing at which a state in which the pedestrian P is not detected (a state in which the pedestrian P is not recognized) occurs due to the irradiation range being changed from the first range to the second range and brightness around the pedestrian P being greatly changed. This makes it possible to prevent the suppression control from being stopped midway due to the state in which the pedestrian P is not detected.

When the suppression control operates again during the time measurement of the second waiting time, the waiting time may not be changed from the second waiting time. In this case, “the suppression control operating again” is an example of a “different suppression control operating.” For example, the time chart of FIG. 6 is referred to. At two times including time T2A and time T2B, the operation of the suppression control starts. Time T2A is a time earlier than time T2, which is the time of output of the light distribution change request. Time T2B is a time during the second waiting time, that is, a time after time T2 and before time T2 + W2. In FIG. 6, the change outputter 120 outputs the light distribution change request at time T2, and the light distribution controller 130 executes the light distribution control at time T2 + W2 after the second time has elapsed from time T2.

Thus, when the suppression control (a “different suppression control”) operates again during the second waiting time, the light distribution controller 130 can execute the light distribution control at an appropriate timing by not changing the waiting time from the set second waiting time. For example, in a scene in which the vehicle M and the oncoming vehicle M1 pass each other during the operation of the suppression control with respect to the pedestrian P, and the light distribution change request is output, the waiting time is not changed when the suppression control operates again during the waiting time of the light distribution control (the second waiting time). When a different suppression control operates, the suppression control operates twice and it can be inferred that a situation requiring the driver's attention has been notified. Therefore, it is inferred that it is important to execute the light distribution control after the second waiting time has elapsed, and improve the visibility for the driver. By improving the visibility for the driver, it becomes possible for the driver to easily ascertain a situation around the vehicle M, and it is possible to suppress the driver overlooking the pedestrian P.

FIG. 7 is a diagram showing an example of a time chart in a scene to which the processing of the present embodiment is applied. The time chart in FIG. 7 is a time chart when the degree of approach between the pedestrian P and the vehicle M does not satisfy the predetermined condition before time measurement of the first waiting time and satisfies the predetermined condition after the start of the time measurement of the first waiting time in the scene of FIG. 5. The time chart in FIG. 7 shows the presence or absence of output of the light distribution change request from the change outputter 120, the irradiation range of the headlamp controlled by the light distribution controller 130, and the presence or absence of the operation of the suppression control in the operation controller 140, similar to the time charts in FIGS. 3 and 6,. At time T3, the change outputter 120 outputs the light distribution change request. In this case, since the suppression control is not operating, the light distribution controller 130 sets the waiting time to the first waiting time and starts time measurement. At time T3, the irradiation range of the headlamp 230 is the first range. At time T3 + R3 after a predetermined time has elapsed from time T3, the suppression control is executed. In this case, the light distribution controller 130 changes the waiting time from the first waiting time to the second waiting time. At time T3 + W3 after the second waiting time has elapsed from time T3, the light distribution controller 130 starts the light distribution control, and the irradiation range of the headlamp 230 is gradually changed from the first range to the second range.

Thus, when the suppression control operates during time measurement of the first waiting time, it is possible to assist in the recognition of an object by changing the waiting time from the first waiting time to the second waiting time. For example, during time measurement of the first waiting time, the vehicle M travels, and thus, the degree of approach between the pedestrian P and the vehicle M satisfies the predetermined condition, and the suppression control with respect to the pedestrian P operates. In this case, by changing the waiting time from the first waiting time to the second waiting time, it is possible to delay the timing at which the state in which the pedestrian P is not detected occurs due to a change in the irradiation range. That is, it is possible to suppress a decrease in recognition accuracy due to a change in the irradiation range. This makes it possible to prevent the suppression control from being stopped halfway due to the state in which the pedestrian P is not detected.

As described above, the light distribution controller 130 may set the waiting time to the first waiting time, start the time measurement of the first waiting time at the first point in time, change the waiting time to the second waiting time when the suppression control has operated, set a start time of the time measurement of the second waiting time as the first point in time, and measure the second waiting time. Referring to the time chart in FIG. 7, the start time of the time measurement of the first waiting time is time T3, and the start time of the time measurement of the second waiting time is also time T3. At time T3 + R3, when the waiting time is changed from the first waiting time to the second waiting time, the start time of the time measurement of the waiting time is not changed.

Thus, when the waiting time is changed from the first waiting time to the second waiting time, it is possible to execute the light distribution control at an appropriate timing by not changing the start time of the time measurement of the waiting time. For example, when the vehicle M and the oncoming vehicle M1 pass each other, the light distribution change request is output, and during time measurement of the first waiting time, the camera 10 detects the pedestrian P existing behind the oncoming vehicle M1 and the suppression control operates, the light distribution controller 130 changes (extends) the waiting time from the first waiting time to the second waiting time. By changing the waiting time from the first waiting time to the second waiting time, with the same first point in time as a start time, the suppression control is appropriately executed and then the light distribution control is promptly executed. By executing the light distribution control at an appropriate timing, it is possible to suppress the driver overlooking the pedestrian P.

When the light distribution control has started and the suppression control operates during control of the gradual change control that is control for gradually changing the irradiation range from the first range to the second range, the light distribution controller 130 may continue the gradual change control. At time T3 + W3 in FIG. 7, the light distribution control starts, and the irradiation range is gradually changed from the first range to the second range. Even when the suppression control operates during the gradual change control after time T3 + W3, the light distribution controller 130 does not set the waiting time and continues the gradual change control since the gradual change control is operating.

Thus, when the suppression control operates during the gradual change control, the gradual change control continues, thereby appropriately assisting the driver in recognizing the surrounding situation as described with reference to FIG. 3.

The light distribution controller 130 may interrupt the gradual change control when the suppression control operates during operation of the gradual change control and resume the gradual change control after a predetermined time has elapsed. The irradiation range during interruption of the gradual change control may be fixed to the irradiation range when the interruption of the gradual change control starts. The predetermined time is a preset time and may be set, for example, according to the type of the vehicle M or may be set according to the installation position of the headlamp 230. The gradual change control is interrupted, thereby making it possible to suppress occurrence of a sudden change in brightness in the imaging range AR3 and prevent the operating suppression control from being stopped.

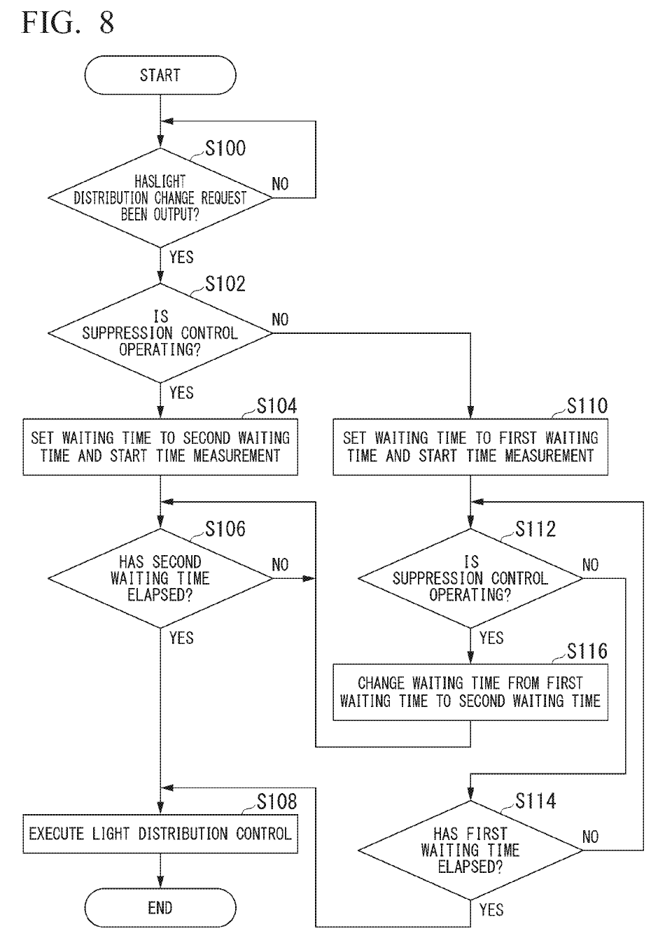

FIG. 8 is a flowchart showing an example of a flow of processing executed by the driving assistance device 100. The flowchart shown in FIG. 8 is executed, for example, when the vehicle M is traveling.

First, the light distribution controller 130 determines whether the light distribution change request from the change outputter 120 has been output (step S100). When the light distribution change request has not been output (step S100: NO), processing of step S100 is executed again. When the light distribution change request has been output (step S100: YES), the light distribution controller 130 determines whether the suppression control in the operation controller 140 is operating (step S102).

In a case in which the suppression control is operating when the light distribution change request is output (step S102: YES), the light distribution controller 130 sets the waiting time to the second waiting time and starts time measurement of the waiting time (step S104). Next, the light distribution controller 130 determines whether the second waiting time has elapsed since the start of the time measurement (step S106). When the second waiting time has not elapsed since the start of the time measurement (step S106: NO), processing of step S106 is executed again. When the second waiting time has elapsed since the start of the time measurement (step S106: YES), the light distribution controller 130 executes the light distribution control for changing the irradiation range from the first range to the second range (step S108). After the processing of step S108 is completed, the driving assistance device 100 ends the processing shown in FIG. 8. When the suppression control operates during elapsing of the second waiting time in step S106, the second waiting time is not changed.

In a case in which the suppression operation is not operating when the light distribution change request is output (step S102: NO), the light distribution controller 130 sets the waiting time to the first waiting time and starts time measurement of the waiting time (step S110). Next, the light distribution controller 130 determines whether the suppression control has operated during the first waiting time (step S112). When the suppression control is not operating (step S112: NO), the light distribution controller 130 determines whether the first waiting time has elapsed since the start of the time measurement (step S114). When the first waiting time has not elapsed (step S114: NO), processing of step S112 is executed again. When the first waiting time has elapsed (step S114: YES), the light distribution controller 130 executes the light distribution control for changing the irradiation range from the first range to the second range (step S108). After completion of the processing of step S108, the driving assistance device 100 ends the processing shown in FIG. 8.

When the suppression control has operated during the first waiting time (step S112: YES), the light distribution controller 130 changes the waiting time from the first waiting time to the second waiting time (step S116). That is, although the suppression control was not operating at the time of output of the light distribution change request, the light distribution controller 130 changes the waiting time from the first waiting time to the second waiting time when the suppression control has operated during time measurement of the first waiting time. Next, the light distribution controller 130 determines whether the second waiting time has elapsed since the start of the time measurement (step S106). Time of the start of the time measurement in the processing of step S106 in this case is time of the start of the time measurement in the processing of step S110. When the second waiting time has not elapsed since the start of the time measurement (step S106: NO), the processing of step S106 is executed again. When the second waiting time has elapsed since the start of the time measurement (step S106: YES), the light distribution controller 130 executes the light distribution control for changing the irradiation range from the first range to the second range (step S108). After completion of the processing of step S108, the driving assistance device 100 ends the processing shown in FIG. 8.

According to the embodiment described above, the light distribution controller 130 is a light distribution controller 130 that performs light distribution control for changing the irradiation range of the headlamp 230 installed in the vehicle M from the first range AR1 to the second range AR2 in which a region above the first range AR1 is illuminated, and can assist in the recognition of an object by changing a timing at which the irradiation range in the light distribution control is changed from the first range AR1 to the second range AR2 in accordance with the operation of the suppression control.

The embodiment described above can be expressed as follows.

A vehicle control device including

a storage device having a program stored therein, and

a hardware processor,

wherein the hardware processor executes the program stored in the storage device to:

recognize an object around a vehicle;

perform suppression control for suppressing the approach of the vehicle to the object when the object exists and a degree of approach between the vehicle and the object satisfies a predetermined condition; and

change a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range.

Although embodiments for carrying out the present invention have been described above, the present invention is not limited in any way to such embodiments, and various modifications and substitutions can be made without departing from the gist of the present invention.

What is claimed is:

1. A vehicle control device comprising:
a storage medium configured to store computer-readable instructions; and
one or more processors connected to the storage medium,
wherein the one or more processors execute the computer-readable instructions to:
recognize an object around a vehicle;
perform suppression control for suppressing the approach of the vehicle to the object
when the object exists and a degree of approach between the vehicle and the object satisfies a predetermined condition; and
change a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range.

2. The vehicle control device according to claim 1, wherein the one or more processors execute the computer-readable instructions to
set a waiting time when changing from the first range to the second range in the light distribution control in accordance with the operation of the suppression control.

3. The vehicle control device according to claim 2, wherein the one or more processors execute the computer-readable instructions to:
set the waiting time to a first waiting time
when the suppression control is not operating during the waiting time; and
set the waiting time to a second waiting time, the second waiting time being a time longer than the first waiting time
when the suppression control is operating at the time of start of time measurement of the waiting time.

4. The vehicle control device according to claim 3, wherein the one or more processors execute the computer-readable instructions to
change the waiting time from the first waiting time to the second waiting time
when the suppression control operates during time measurement of the first waiting time.

5. The vehicle control device according to claim 4, wherein the one or more processors execute the computer-readable instructions to:
when
the waiting time is set to the first waiting time,
time measurement of the first waiting time is started from a first point in time, and
the suppression control operates after the time measurement is started,
change the waiting time from the first waiting time to the second waiting time; and
start time measurement of the second waiting time from the first point.

6. The vehicle control device according to claim 3, wherein the one or more processors execute the computer-readable instructions to
when
the waiting time is set to the second waiting time according to the suppression control, and
a different suppression control operates during time measurement of the second waiting time,
prevent changing the waiting time from the second waiting time.

7. The vehicle control device according to claim 4, wherein the one or more processors execute the computer-readable instructions to:
perform control for gradually changing the irradiation range from the first range to the second range in the light distribution control; and
continue the gradually changing control
when the suppression control operates during the gradually changing control after the waiting time has elapsed.

8. A vehicle control method comprising:
recognizing, by a computer, an object around a vehicle;
performing, by the computer, suppression control for suppressing the approach of the vehicle to the object when the object exists and a degree of approach between the vehicle and the object satisfies a predetermined condition; and
changing a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range.

9. A non-transitory storage medium storing a program that causes a computer to:
recognize an object around a vehicle;
perform suppression control for suppressing the approach of the vehicle to the object when the object exists and a degree of approach between the vehicle and the object satisfies a predetermined condition; and
change a timing at which the irradiation range in light distribution control is changed from a first range to a second range in accordance with an operation of the suppression control, the light distribution control being control for changing an irradiation range of the headlamp installed in the vehicle from the first range to the second range, the second range being a region above the first range.
